(19) United States
(12) Patent Application Publication
(10) Pub. No.: US 2017/0170591 A1
(43) Pub. Date: Jun. 15, 2017

(54) TERMINAL FITTING AND CONNECTOR

(71) Applicant: Sumitomo Wiring Systems, Ltd., Yokkaichi (JP)

(72) Inventor: Katsuya Uezono, Yokkaichi (JP)

(21) Appl. No.: 15/362,941

(22) Filed: Nov. 29, 2016

(30) Foreign Application Priority Data
Dec. 14, 2015 (JP) 2015-242781

(51) Int. Cl. H01R 13/40

(52) U.S. Cl. CPC H01R 13/40

(57) ABSTRACT

A terminal fitting includes a wire connecting portion (11) to be connected to an end part of a wire W. A terminal body (12) is provided in front of the wire connecting portion (11) and has a substantially square cross-section. A projection (23) projects in a direction intersecting a front-back direction from the terminal body (12), and a cover (33) is provided in front of the projection (23) and is inclined to gradually increase a projecting dimension toward back. The cover (33) is configured to cover a front surface of the projection (23).

### BACKGROUND

1. Field of the Invention

The invention relates to a terminal fitting and a connector provided therewith.

2. Description of the Related Art

Conventionally, a terminal fitting is to be accommodated into a cavity of a connector housing while being connected to an end part of a wire. The terminal fitting of this type generally includes a wire connecting portion to be connected to the end part of the wire. A terminal body is located in front of the wire connecting portion and has a substantially square cross-section.

Some terminal fittings of this type have a projection on the terminal body to prevent the terminal fitting from being inserted in a wrong orientation into a cavity. For example, Japanese Unexamined Patent Publication No. 2009-252495 discloses a terminal fitting with a projection in a widthwise central part of the terminal body. The projection enters a groove formed in a cavity if the terminal fitting is in a correct orientation and contacts the rear end of a connector housing if the terminal fitting is in a wrong orientation. In this way, the terminal fitting can be prevented from being inserted in a wrong orientation into the cavity.

In recent years, it has been desired to make terminal fittings usable in both waterproof and non-waterproof connectors. A terminal fitting for waterproof application is accommodated into a cavity through a through hole of a seal mounted in a rear part of a housing when a waterproof connector is assembled. However, the projection of a terminal fitting may damage the seal when the terminal fitting passes through the through hole of the seal. Thus, the use of this terminal fitting for waterproof application is not suitable in terms of quality.

The present invention was completed based on the above situation and aims to provide a terminal fitting usable as a terminal fitting for waterproof application.

### SUMMARY

The invention relates to a terminal fitting with a wire connecting portion to be connected to an end part of a wire. A terminal body is provided in front of the wire connecting portion and has a tubular box. A projection projects from the terminal body in a direction intersecting a front-back direction. A cover is provided in front of the projection and inclines to increase a projecting dimension gradually toward the back and is configured to cover a front surface of the projection.

The projection may be formed by striking a part of a side wall of the terminal body portion. According to this configuration, material cutting of a plate material for forming the terminal fitting can be improved.

The front and/or rear surfaces of the projection may be open in the front-back direction. Accordingly, a height of the projection by striking can be made larger as compared to the case where at least one of the front and rear surfaces is closed (connected to the terminal body portion). Thus, the height of the projection can be made sufficiently large by striking.

The projection may include at least one standing wall standing along a side surface of the terminal body from a corner part of the terminal body. If a projection is provided in a widthwise central part of a terminal body, the terminal body may incline in the lateral direction. Thus, the projection may enter a corner part of a cavity and a terminal fitting may be inserted erroneously although the terminal fitting is in a wrong orientation. However, according to the configuration described above, if the terminal fitting is inclined toward one side in the lateral direction, the standing wall is located in a widthwise intermediate part of the cavity. If the terminal fitting is inclined toward the other side, the standing wall is located in an intermediate part of the cavity in a height direction. Thus, it can be prevented that the projection enters a corner part of the cavity and the terminal fitting forcibly is inserted erroneously, with the result that a force for preventing erroneous insertion of the terminal fitting can be enhanced.

A projection may be provided on a tip of the cover in a standing direction and may project to a position of the corner part of the terminal body. The projection on the cover is located in front of the standing wall. Thus, the standing wall will not damage the seal when the terminal fitting is passed through the through hole of the seal.

The projection may be closer to one end side of the terminal body portion in a width direction.

A width of the projection may be larger than substantially half the width of the terminal body.

A projecting side portion of the projection may stand oblique to gradually narrow a width of the projection from the base end toward the distal end.

The invention also relates to a connector comprising a connector housing having at least one cavity in which the above-described terminal fitting is inserted.

The cavity includes a body inserting portion having a cross-section substantially in conformity with the outer shape of the terminal body and a projection inserting portion having a cross-section substantially in conformity with the outer shape of the projection.

According to the invention, the projection can be prevented from damaging a seal when the terminal fitting is passed through a through hole of the seal. Thus, the terminal fitting can be used for a waterproof application.

These and other features of the invention will become more apparent upon reading the following detailed description and accompanying drawings. It should be understood that even though embodiments are described separately single features may be combined to additional embodiments.

### BRIEF DESCRIPTION OF THE DRAWINGS

FIG. 1 is a perspective view showing a terminal fitting of an embodiment in a state connected to an end of a wire.

FIG. 2 is a front view showing the terminal fitting in the state connected to the end of the wire.

FIG. 3 is a rear view showing the terminal fitting in the state connected to the end of the wire.

FIG. 4 is a plan view showing the terminal fitting.

FIG. 5 is a side view showing one side of the terminal fitting.

FIG. 6 is a side view showing the other side of the terminal fitting.

FIG. 7 is a partial enlarged perspective view of a connector showing a state where the terminal fitting is inserted in a correct orientation into a cavity.

FIG. 8 is a partial enlarged rear view of the connector showing the state where the terminal fitting is inserted in the correct orientation into the cavity.

FIG. 9 is a section of the connector showing the state where the terminal fitting is inserted in the correct orientation into the cavity.

FIG. 10 is a partial enlarged perspective view of the connector showing a state where erroneous insertion of the terminal fitting is prevented

FIG. 11 is a partial enlarged rear view of the connector showing the state where erroneous insertion of the terminal fitting is prevented.

FIG. 12 is a section of the connector showing the state where erroneous insertion of the terminal fitting is prevented.

### DETAILED DESCRIPTION

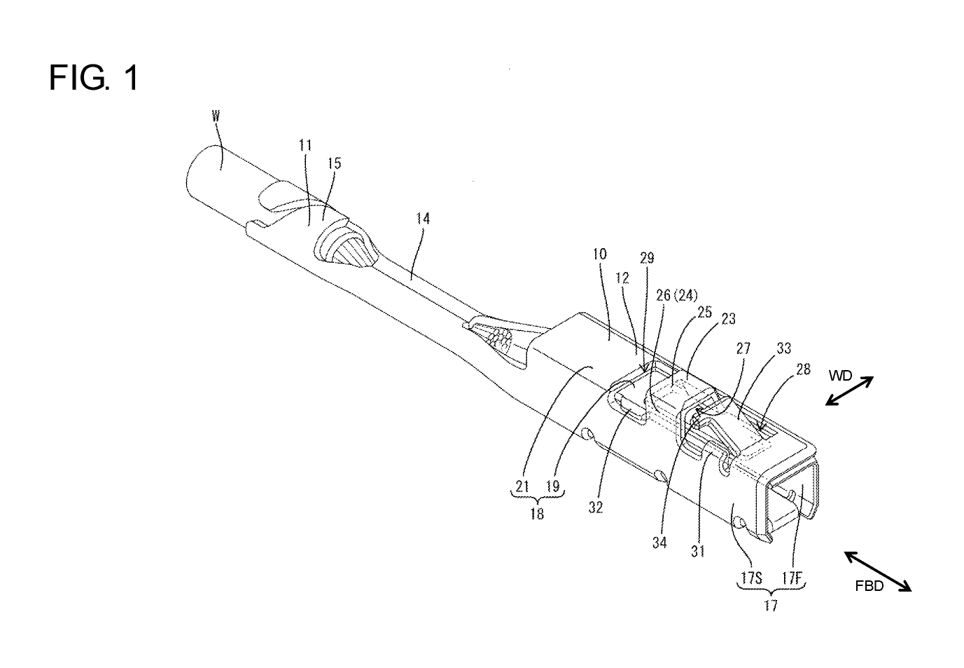

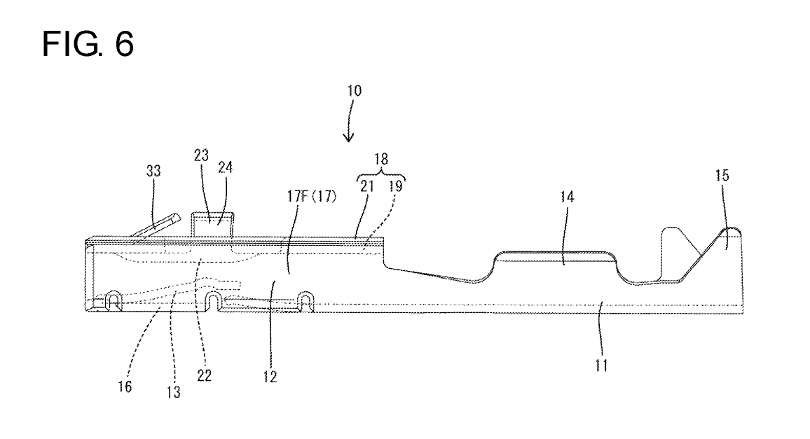

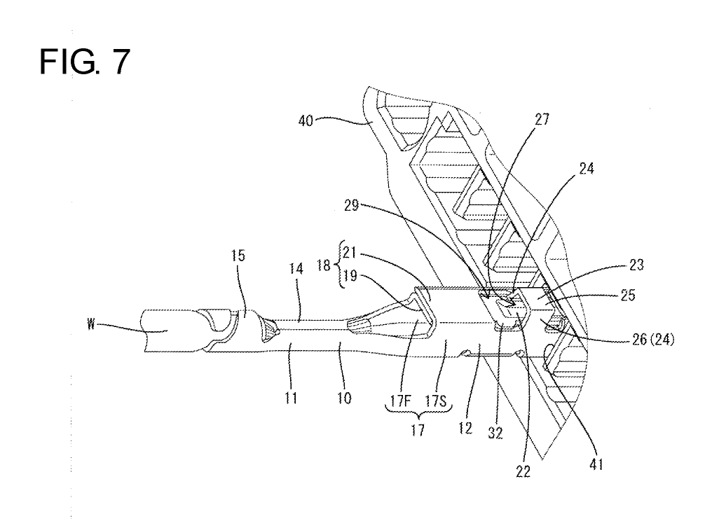

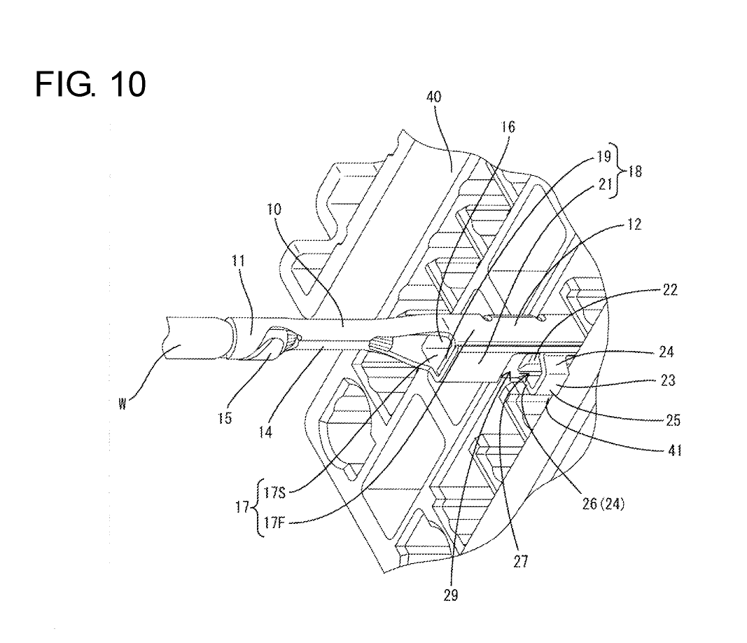

Hereinafter, one specific embodiment of the present invention is described with reference to FIGS. 1 to 12.

A terminal fitting 10 in this embodiment is to be accommodated into a cavity 41 of a connector housing 40 while being connected to an end part of a wire W. The terminal fitting 10 is formed by punching out a conductive metal plate into a predetermined shape and, then, bending the punched-out metal piece into a predetermined shape. In the following description, in each constituent member, a right-lower side of FIG. 1 (side to be connected to a mating terminal fitting) is referred to as a front end, a left-upper side of FIG. 1 (side to be connected to the wire W) is referred to as a rear end, an upper side of FIG. 1 (side where a projection 23 to be described later is provided) is referred to as an upper side and a lower side of FIG. 1 is referred to as a lower side.

The terminal fitting 10 includes a wire connecting portion 11 to be connected to the end part of the wire W and a terminal body 12 provided in front of the wire connecting portion 11. The terminal fitting 10 is a female terminal fitting, and a tab of an unillustrated mating terminal fitting is insertable into the terminal body 12 from the front.

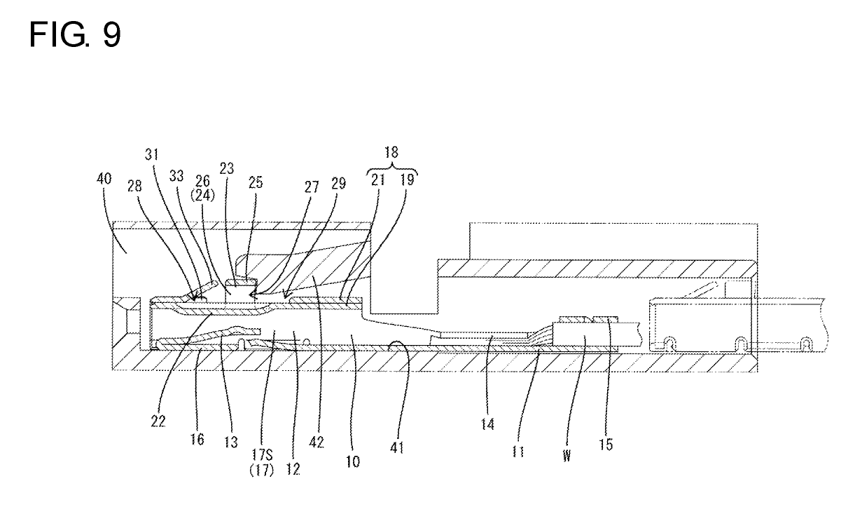

A contact piece 13 is provided inside the terminal body 12 and can contact the mating terminal fitting. As shown in FIG. 9, the contact piece 13 is formed by folding back a piece extending from the front end of a bottom wall 16 of the terminal body 12 to be described later. The contact piece 13 is in the form of a cantilever whose rear end is a free and can resiliently contact the tab of the unillustrated mating terminal fitting.

The wire connecting portion 11 includes a wire barrel 14 to be crimped to a conductor exposed at the end part of the wire W and an insulation barrel 15 to be crimped to an end part of an insulation coating.

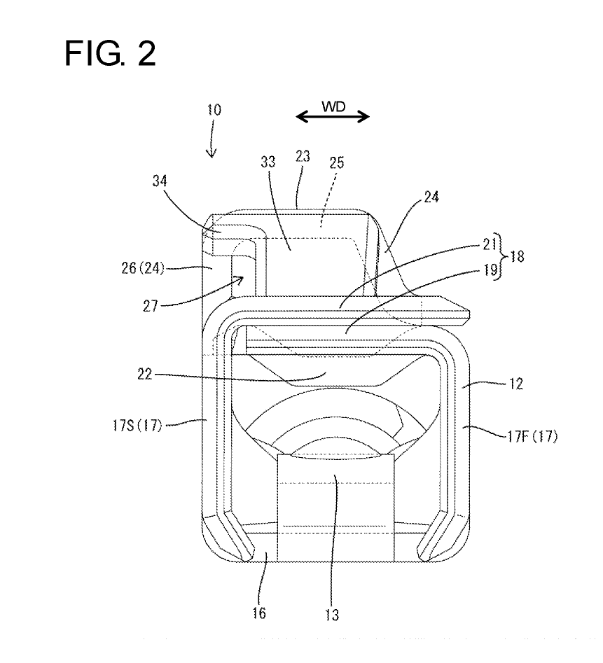

As shown in FIG. 2, the terminal body 12 has a substantially square cross-section and includes the bottom wall 16, left and right side walls 17 bent up from both left and right sides of the bottom wall 16 and standing up, and a ceiling wall 18 arranged between upper end parts of the left and right side walls 17 and vertically facing the bottom wall 16.

As shown in FIG. 2, the ceiling wall 18 includes an inner wall 19 arranged inside the terminal body 12 and an outer wall 21 arranged outside. The inner wall 19 is continuous with a first side wall 17F, and bent substantially at a right angle from the upper end of the first side wall 17F. The outer wall 21 is continuous with a second side wall 17S and is bent at a substantially right angle from the upper end of the second side wall 17S.

The ceiling wall 18 is provided with a bulge 22 bulging slightly in. The bulge 22 is provided in a widthwise central part of the inner wall 19 of the ceiling wall 18. The bulge 22 is formed in a part of the ceiling wall 18 vertically facing the contact piece 13. The tab of the mating terminal fitting is to be sandwiched between the bulge 22 and the contact piece 13.

The terminal fitting 10 includes the projection 23 projecting out (in a direction intersecting with a front-back direction FBD) from the terminal body 12. The projection 23 projects out or up from the upper surface of the terminal body 12. The projection 23 is provided closer to one end side of the terminal body 12 in a width direction WD. A width of the projection 23 is larger than substantially half the width of the terminal body 12.

The projection 23 is formed by striking a part of the ceiling wall 18 (side wall constituting the terminal body 12). The projection 23 is formed on the outer wall 21 of the ceiling wall 18. As shown in FIG. 9, the projection 23 is located above a rear part of the bulge 22.

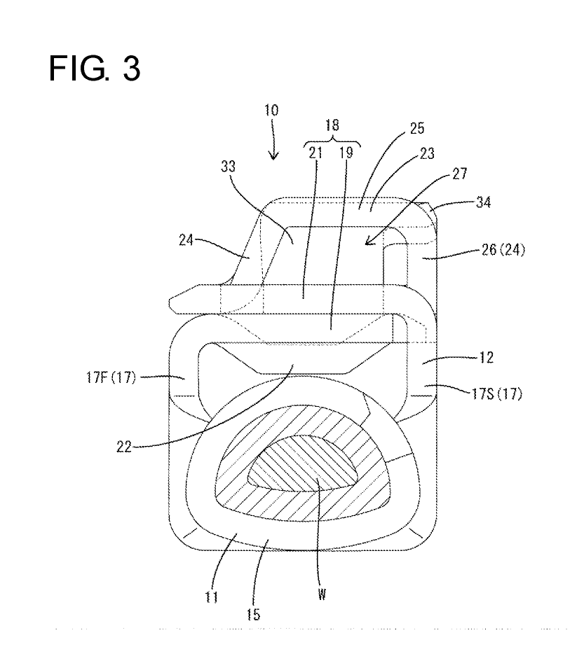

As shown in FIG. 3, the projection 23 includes two projecting sides 24 standing on the outer surface of the terminal body 12 and a projecting ceiling 25 bridging between upper end parts of the two projecting sides 24. The projecting ceiling 25 faces the upper surface of the terminal body 12 substantially in parallel.

One of the projecting sides 24 defines a standing wall 26 standing along a side surface of the terminal body 12 from a corner part of the terminal body 12. The standing wall portion 26 is substantially at a right angle to the upper surface of the terminal body 12. As shown in FIG. 1, the standing wall 26 is continuous with the second side wall 17S of the terminal body 12 and a part of the second side wall 17S projecting up.

The projecting side 24 facing the standing wall 26 stands oblique to gradually narrow a width of the projection 23 (approach the standing wall portion 26) from the lower end toward the upper end, as shown in FIG. 3.

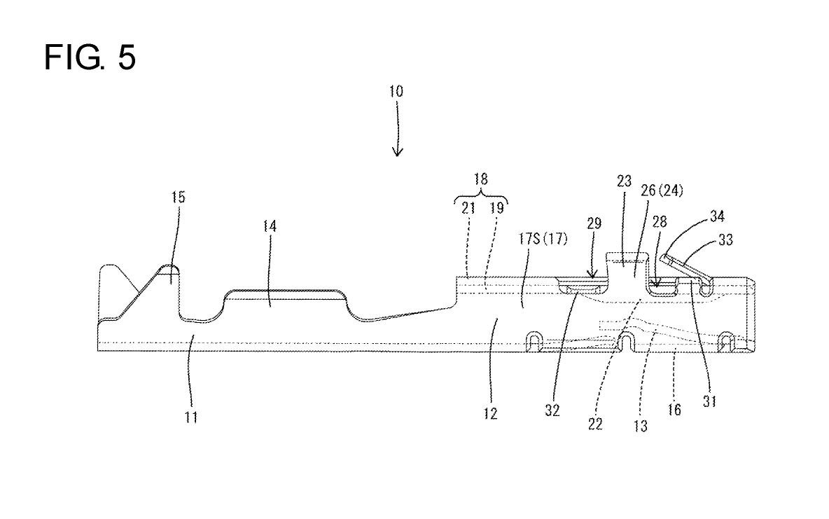

The projection 23 is shaped to be open both forward and backward and projecting openings 27 open in the front-back direction FBD are formed in the front and rear surfaces of the projection 23. As shown in FIG. 3, the projecting opening 27 is surrounded by the projecting sides 24 and the projecting ceiling 25 and has a substantially square shape when viewed in the front-back direction FBD. Note that the front and rear surfaces of the projection 23 are both vertical (substantially orthogonal to the front-back direction FBD) as shown in FIG. 5.

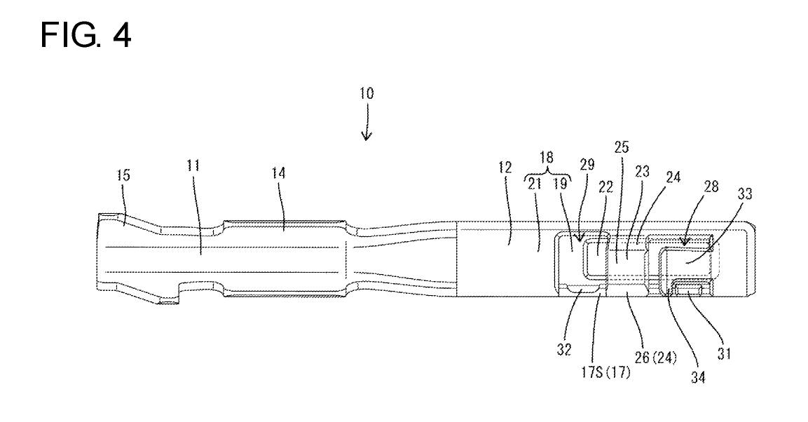

Openings penetrate through the outer wall 21 of the ceiling 18 in a wall thickness direction are formed at opposite sides across the projection 23 in the front-back direction FBD as shown in FIG. 4. Hereinafter, the opening on the front side is referred to as a front opening 28 and the opening on the rear side is referred to as a rear opening 29. The front and rear openings 28, 29 are formed adjacent to front and rear sides of the projection 23. The front and rear openings 28, 29 have a square shape extending over the entire width of the ceiling 18. The front and rear openings 28, 29 are both formed over a corner part between the ceiling wall 18 and the second side wall 17S.

As shown in FIG. 9, inner sides of the front and rear openings 28, 29 are entirely covered by the inner wall 19. A front part of the bulge 22 is facing the front opening 28 and a rear end part of the bulge 22 is facing the rear opening 29.

As shown in FIG. 4, the front opening 28 is formed by cutting and raising a cover 33 to be described later. The front opening 28 has a rectangular shape long in the front-back direction FBD. The rear opening 29 has a width slightly larger than a dimension in the front-back direction FBD. The rear opening is smaller than the front-back direction FBD than the front opening 28.

As shown in FIGS. 4 and 5, a covering wall 31 stands on an edge of the front opening 28 (upper end of the second side wall 17S). The covering wall 31 is located in a front part of the front opening 28. The covering wall 31 covers the base end of the cover 33 to be described later and prevents external matter from entering the cover 33 or being caught by the cover 33.

As shown in FIGS. 4 and 5, a contact portion 32 provided on the inner wall 19 of the ceiling wall 18 is in contact with an edge of the rear opening 29 (upper end of the second side wall 17S) from above.

As shown in FIG. 1, the terminal fitting 10 includes the cover 33 for covering the front surface of the projection 23. The cover 33 is provided in front of the projection 23 and inclined up toward the back to gradually increase a projecting dimension. Similarly to the projection 23, the cover 33 is closer to one end side in the width direction WD of the terminal body 12.

The cover 33 is formed by cutting and obliquely raising a widthwise intermediate part (excluding corner parts) of the outer wall 21 of the ceiling wall 18. The cover 33 has, as a whole, a rectangular shape having a shorter width than a dimension in a standing direction. The width of the cover 33 (dimension in a short side direction) is smaller than the entire width of the projection 23.

The rear end of the cover 33 is located at the same height as the projection 23 as shown in FIG. 9. A rear end part of the cover 33 (tip part in the standing direction) is arranged in front of and close to the upper end of the projection 23. Note that the cover 33 is located above a front part of the bulge 22.

A projecting portion 34 projecting to the position of the corner part of the terminal body 12 as shown in FIG. 2 is provided at a rear end part of the cover 33. The projecting portion 34 projects outward in the width direction WD of the cover 33 and the projecting end thereof is located at a widthwise end of the terminal body 12. The projecting portion 34 is arranged to face a corner part of the projection 23 between the standing wall 26 and the projecting ceiling 25 in the front-back direction FBD.

The connector housing 40 is made of synthetic resin and cavities 41 are formed side by side in the vertical and lateral directions. As shown in FIG. 9, the terminal fitting 10 is to be accommodated into each cavity 41 from behind. Each cavity 41 is provided with a locking lance 42 capable of locking the terminal fitting 10 inserted to a proper position and retaining the terminal fitting 10. The locking lance 42 is cantilevered forward and formed in a front part of the cavity 41. The locking lance 42 is for locking the rear surface of the projection 23 of the terminal fitting 10 from behind.

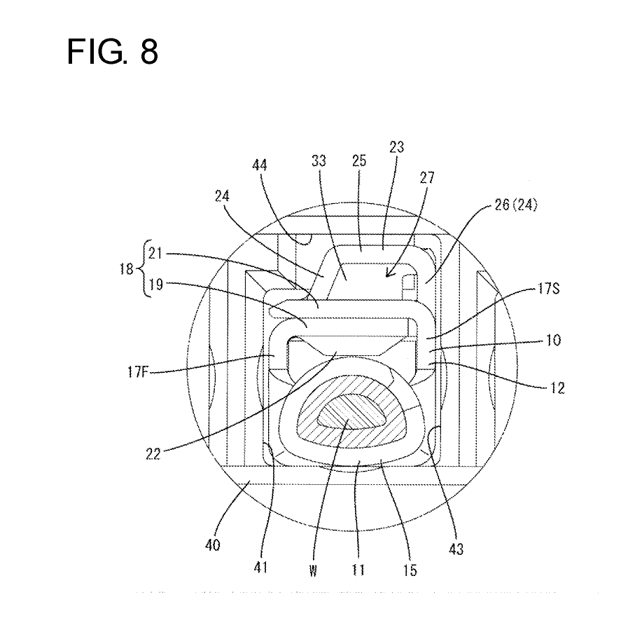

As shown in FIG. 8, each cavity 4 includes a body inserting portion 43 having a substantially square cross-section in conformity with the outer shape of the terminal body 12, and a projection inserting portion 44 having a substantially square cross-section in conformity with the outer shape of the projection 23. The projection inserting portion 44 is formed above the body inserting portion 43. The projection inserting portion 44 is located closer to one side in a width direction WD of the body inserting portion 43.

As shown in FIG. 8, the projection 23 is inserted together with the cover 33 into the projection inserting portion 44 if the terminal fitting 10 is in a correct orientation (in this embodiment, an orientation in which the projection 23 is arranged on an upper side). In this way, the terminal fitting 10 can be inserted to the back of the cavity 41, thereby being accommodated at a proper position as shown in FIG. 9.

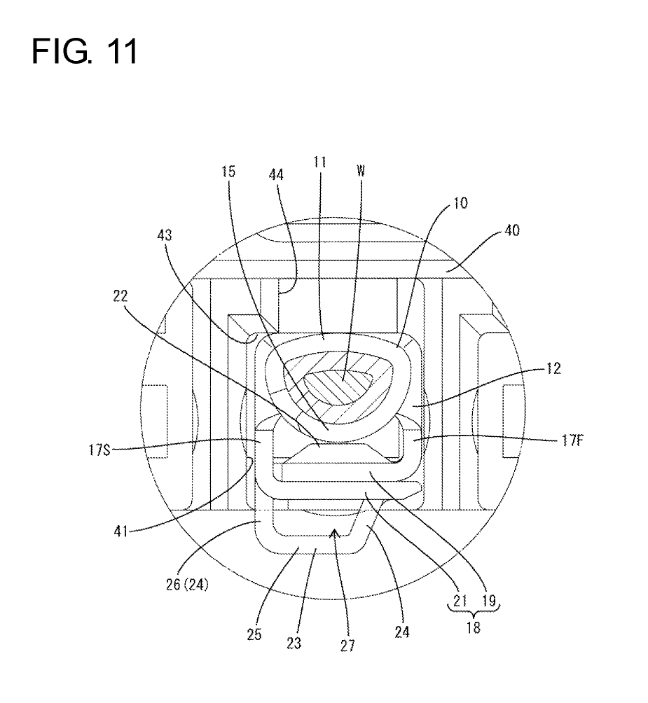

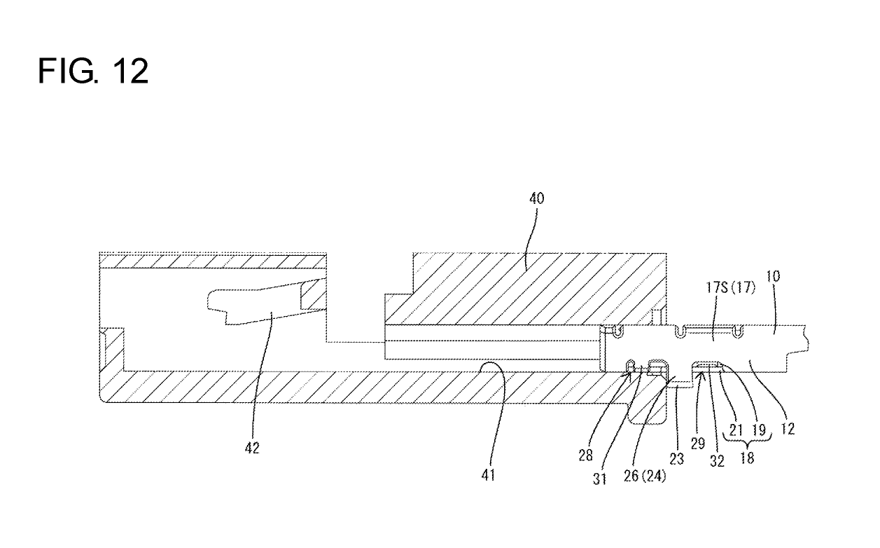

If the terminal fitting 10 is in a wrong orientation (in this embodiment, an orientation in which the projection 23 is arranged on a lower side) as shown in FIG. 11, the projection 23 abuts against the rear end of the connector housing 40 as shown in FIG. 12. Note that the terminal fitting 10 is pushed with a strong force, whereby the cover 33 strongly abuts against the rear end of the connector housing 40 to be inclined into the front opening 28 and enter the cavity 41.

With the terminal fitting 10 of this embodiment, the projection 23 reliably abuts against the rear end of the connector housing 40 even if the terminal body portion 12 is inclined. Specifically, if the terminal fitting 10 is inclined toward one side in the lateral direction (e.g. in the case of counterclockwise rotation in FIG. 11), the standing wall 26 is located in an intermediate part in a width direction WD of the cavity 41 (intermediate part of the lower side wall). If the terminal fitting 10 is inclined toward the other side (in the case of clockwise rotation in FIG. 11), the standing wall 26 is located in an intermediate part in a height direction of the cavity 41 (intermediate part of the left side wall). Thus, even if the terminal fitting 10 is inclined, the projection 23 (standing wall 26) reliably abuts against the rear end of the connector housing 40. Hence, the projection 23 does not forcibly enter a corner part of the cavity 41 and reliably prevents erroneous insertion of the terminal fitting 10. Therefore, the terminal fitting 10 can be reliably prevented from being erroneously inserted in a vertically wrong orientation into the cavity 41.

Next, functions and effects of the embodiment configured as described above are described.

The terminal fitting 10 of this embodiment includes the wire connecting portion 11 to be connected to the end part of the wire. The terminal body 12 is provided in front of the wire connecting portion 11 and has a substantially square cross-section. The projection 23 projects in a direction intersecting the front-back direction FBD from the terminal body 12. The cover 33 is provided in front of the projection 23, and is inclined to gradually increase the projecting dimension toward the back and is configured to cover the front surface of the projection 23.

According to this configuration, the front surface of the projection 23 (edges at the front ends of the projecting ceiling 25 and the projecting side portions 24) will not damage a seal when the terminal fitting 10 is passed through a through hole of the seal. Thus, the terminal fitting 10 can be used as a terminal fitting for waterproof application.

Further, the projection 23 is formed by striking a part of the ceiling wall 18 constituting the terminal body 12. According to this configuration, plate material cutting can be improved.

Further, the front and rear surfaces of the projection 23 are open in the front-back direction FBD. According to this configuration, a height of the projection 23 by striking can be made larger as compared to the case where both front and rear surfaces are or one of them is closed (connected to the terminal body 12). Thus, the height of the projection 23 can be made sufficiently large also by striking. Specifically, if neither of the front and rear surfaces of the projection 23 are open, a limit of a striking height is about 2 to 2.5 times as large as the plate thickness. Since the both front and rear surfaces are open, a striking height that is three times as large as the plate thickness can be realized. Thus, a locking force with the locking lance 42 and a force for preventing erroneous insertion can be made sufficiently large. Further, even if the height of the projection 23 is increased in this way, the seal can be prevented from being damaged when the terminal fitting 10 is passed through the through hole of the seal since the front surface of the projection 23 is covered by the cover 33.

Further, the projection 23 particularly includes the standing wall 26 standing substantially along the side surface of the terminal body 12 from the corner part of the terminal body 12. Here, if a projection is provided in a widthwise central part of a terminal body, the terminal body may be inclined in the lateral direction, the projection may enter a corner part of the cavity 41 and a terminal fitting may be erroneously inserted although the terminal fitting is in a wrong orientation. However, according to the configuration as described above, if the terminal fitting 10 is inclined toward one side in the lateral direction, the standing wall 26 is located in the widthwise intermediate part of the cavity 41. If the terminal fitting 10 is inclined toward the other side, the standing wall 26 is located in the intermediate part of the cavity 41 in the height direction. Thus, the projection 23 cannot enter the corner part of the cavity 41 and the terminal fitting 10 cannot forcibly be inserted erroneously, with the result that a force for preventing erroneous insertion of the terminal fitting 10 can be enhanced.

Further, the projecting portion 34 projecting to the position of the corner part of the terminal body 12 is provided on the tip part of the cover 33 in the standing direction. According to this configuration, since the projecting portion 34 provided on the cover 33 is located in front of the standing wall 26, the standing wall 26 can be prevented from damaging the seal when the terminal fitting 10 is passed through the through hole of the seal member.

The invention is not limited to the above described embodiment. For example, the following embodiments also are included in the scope of the invention.

Although the invention is applied to the female terminal fitting 10 in the above embodiment, there is no limitation to this and the invention can also be applied to male terminal fittings in which a tab configured to contact a mating terminal fitting is provided to project in front of a terminal body.

Although the projection 23 is formed by striking a part of the ceiling wall 18 in the above embodiment, there is no limitation to this and the projection may be formed, for example, by bending the ceiling wall.

Although the locking lance 42 is locked to the projection 23 in the above embodiment, there is no limitation to this and a locking position of the locking lance can be arbitrarily changed. For example, the locking lance may be locked to the rear end of the terminal body portion.

Although the projection 23 includes the standing wall portion 26 standing along the side surface of the terminal body portion 12 from the corner part of the terminal body portion 12 in the above embodiment, there is no limitation to this and the projection may not necessarily include the standing wall portion and provided in the widthwise central part of the terminal body portion.

### REFERENCE SIGNS

W . . . wire
10 . . . terminal fitting
11 . . . wire connecting portion
12 . . . terminal body portion
18 . . . ceiling wall (side wall constituting terminal body portion)
23 . . . projection
26 . . . standing wall portion
33 . . . cover portion
34 . . . projecting portion

What is claimed is:

1. A terminal fitting (10), comprising:
a wire connecting portion (11) to be connected to a wire (W);
a terminal body (12) provided adjacent to the wire connecting portion (11);
a projection (23) projecting in a direction intersecting with a front-back direction (FBD) from the terminal body (12); and
a cover (33) provided in front of the projection (23), inclined to gradually increase a projecting dimension toward back and configured to at least partly cover a front surface of the projection (23).

2. The terminal fitting of claim 1, wherein the front and/or rear surfaces of the projection (23) are open in the front-back direction (FBD).

3. The terminal fitting of claim 1, wherein the projection (23) includes at least one standing wall (26) standing substantially along a side surface of the terminal body (12) from a corner part of the terminal body (12).

4. The terminal fitting of claim 1, wherein a projecting portion (34) projecting to a position of the corner part of the terminal body (12) is provided on a tip part of the cover (33) in a standing direction.

5. The terminal fitting of claim 1, wherein the projection (23) is closer to one end side of the terminal body (12) in a width direction (WD).

6. The terminal fitting of claim 1, wherein a width of the projection (23) is larger than half a width of the terminal body (12).

7. The terminal fitting of claim 1, wherein a projecting side portion (24) of the projection (23) is obliquely standing to gradually narrow a width of the projection (23) from the base end toward the distal end.

8. A connector comprising: a connector housing (40) having at least one cavity (41) and the terminal fitting (10) of claim 1.

9. The connector of claim 8, wherein the cavity (41) includes a body inserting portion (43) having a cross-section substantially in conformity with the outer shape of the terminal body (12) and a projection inserting portion (44) having a cross-section substantially in conformity with the outer shape of the projection (30).
